(19) United States
(12) Patent Application Publication
(10) Pub. No.: US 2026/0066421 A1
(43) Pub. Date: Mar. 5, 2026

(54) VEHICLE BATTERY CASE

(71) Applicant: TOYOTA JIDOSHA KABUSHIKI KAISHA, Toyota-shi (JP)

(72) Inventor: Naoto KAGEYAMA, Nagoya-shi (JP)

(73) Assignee: TOYOTA JIDOSHA KABUSHIKI KAISHA, Toyota-shi (JP)

(21) Appl. No.: 19/176,311

(22) Filed: Apr. 11, 2025

(30) Foreign Application Priority Data
Aug. 29, 2024 (JP) 2024-147541

(51) Int. Cl. H01M 50/24; H01M 50/249; B60K 1/04; B60L 50/64

(52) U.S. Cl. CPC H01M 50/24; H01M 50/249; B60K 1/04; B60L 50/64; H01M 2220/20

(57) ABSTRACT

A battery case of a battery has an internal space that is provided by an upper case and a lower case stacked together and in which a battery pack is housed. A framework part is attached to the lower case such that a flat portion is in surface contact with a backside of a bottom plate. The bottom plate is provided with a recess extending from a contact area where the flat portion is in surface contact with the bottom plate to a non-contact area within a notch of the framework part. This allows a coating liquid to flow around the contact area even with the framework part attached in the lower case, and thus it is possible to restrain uneven coating, such as a thin coating film or an exposed base material, and restrain the formation of rust and the progression of rust.

### CROSS-REFERENCE TO RELATED APPLICATION

This application claims priority to Japanese Patent Application No. 2024-147541 filed on August 29, 2024. The disclosure of the above-identified application, including the specification, drawings, and claims, is incorporated by reference herein in its entirety.

### BACKGROUND

### 1. Technical Field

The present disclosure relates to a vehicle battery case.

### 2. Description of Related Art

Japanese Unexamined Patent Application Publication No. 2021-123227 (JP 2021-123227 A) describes a battery pack that is installed on a vehicle floor. The battery pack includes a plurality of battery cells arranged in a battery pack case. The battery pack case includes a lower case in which the battery cells are arranged side by side, and an upper case that isolates the space in the lower case in which the battery cells are arranged from the surrounding area. In addition, the lower case of the battery pack case is fixed to the vehicle floor.

### SUMMARY

On the other hand, the battery pack case (battery case) uses steel plates or the like for the lower case and the upper case, and the lower case and the upper case are subjected to electrodeposition coating or the like to improve rust resistance. In electrodeposition coating, for example, the lower case or the upper case as an object to be coated is immersed in an electrodeposition coating liquid containing an electrically charged cationic resin as a coating, and an electrodeposition voltage according to preset electrodeposition conditions is applied across the object to be coated (cathode) that is one of electrodes and the other electrode (anode) placed in the electrodeposition coating liquid. Due to the coating film (resin coating film) that contains the cationic resin and is formed on the surface of the object to be painted, such as the lower case, the formation of rust and the like is restrained.

Incidentally, various parts are attachable to the battery case, etc., for use in fixing the battery case to the vehicle body. Each of the upper case and the lower case of the battery case may be subjected to coating with these parts attached. In this case, for example, when another part is in surface contact with the outer surface of the lower case, the coating liquid may not easily permeate to the contact surface with the other part. Consequently, there may be a case in which a coating film is not formed properly or the base material is exposed. When the coating film is not formed properly on the outer surface of the battery case or when the base material is exposed, rust will be formed or the formed rust will progress. Accordingly, there is room for improvement in coating (coating film formation).

The present disclosure has been made in consideration of the above circumstances, and it is an object of the present disclosure to provide a vehicle battery case that allows for appropriate coating even when mounting parts are in surface contact with the vehicle battery case and attached to the vehicle battery case.

In order to achieve the above object, a vehicle battery case according to a first aspect includes: a case body that houses a battery module including a plurality of stacked battery cells in an internal space; and a mounting part that is subjected to coating together with the case body, the mounting part being attached to an outer surface of the case body such that the mounting part is in surface contact with the outer surface. The outer surface of the case body is provided with a groove-shaped recess that extends from a contact area to a non-contact area that does not contact with the mounting part, the contact area being in surface contact with the mounting part with the mounting part attached.

In the vehicle battery case according to the first aspect, the battery module including the stacked battery cells is housed in the internal space of the case body. The mounting part is attached to the case body such that the mounting part is in surface contact with the outer surface. Moreover, the case body is subjected to coating with the mounting part attached.

Here, the outer surface of the case body is provided with the groove-shaped recess. The recess extends from the contact area to the non-contact area that does not contact with the mounting part. The contact area is in surface contact with the mounting part with the mounting part attached.

Therefore, in the outer surface of the case body, a coating that enters the recess in the non-contact area moves along the recess and reaches the contact area, so that a coating film can be properly formed even in the contact area. This makes it possible to restrain the formation of rust and the progression of rust on the outer surface of the case body.

In the vehicle battery case according to a second aspect, in the first aspect, the case body includes a lower case on which the battery module is mounted, and an upper case covering the lower case and defining an internal space that is between the upper case and the lower case and in which the battery module is housed. The recess is provided in the lower case.

In the vehicle battery case according to the second aspect, the case body includes the upper case and the lower case, and the recess is provided in the lower case. This makes it possible to properly perform coating for the lower case even when the mounting part for supporting the case body on the vehicle body is attached to the lower case, and effectively restrain the formation of rust and the progression of rust on the lower case.

In the vehicle battery case according to a third aspect, in the second aspect, the recess is provided in a front end of the lower case in a front-rear direction of a vehicle.

In the vehicle battery case according to the third aspect, the recess is provided in the front end of the lower case in the front-rear direction of the vehicle. This makes it possible to improve the rigidity of a front side portion of the lower case in the front-rear direction of the vehicle, and restrain deformation of the lower case even when the lower case receives a load on the front side in the front-rear direction of the vehicle in the event of an emergency of the vehicle.

According to the aspects of the present disclosure, even when the mounting part is attached to the outer surface of the case body such that the mounting part is in surface contact with the outer surface of the case body, it is possible to promote the penetration of the coating into the contact surface. This allows the coating film to be appropriately formed on the case body without the exposed base material. Accordingly, the aspects of the present disclosure have an effect of restraining the formation of rust and the progression of rust even when rust is formed on the case body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic configuration of a battery according to an embodiment;

FIG. 2 is a plan view illustrating a main portion of a lower case as viewed from below;

FIG. 3 is a perspective view illustrating an outline of the main portion of the lower case as viewed diagonally from above on a rear left side; and

FIG. 4 is a plan view illustrating the main portion of the lower case according to a modification as viewed from below.

### DETAILED DESCRIPTION OF EMBODIMENTS

A vehicle battery case according to an embodiment of the present disclosure will be described in detail below with reference to the drawings. The vehicle battery case is mounted in a vehicle for use.

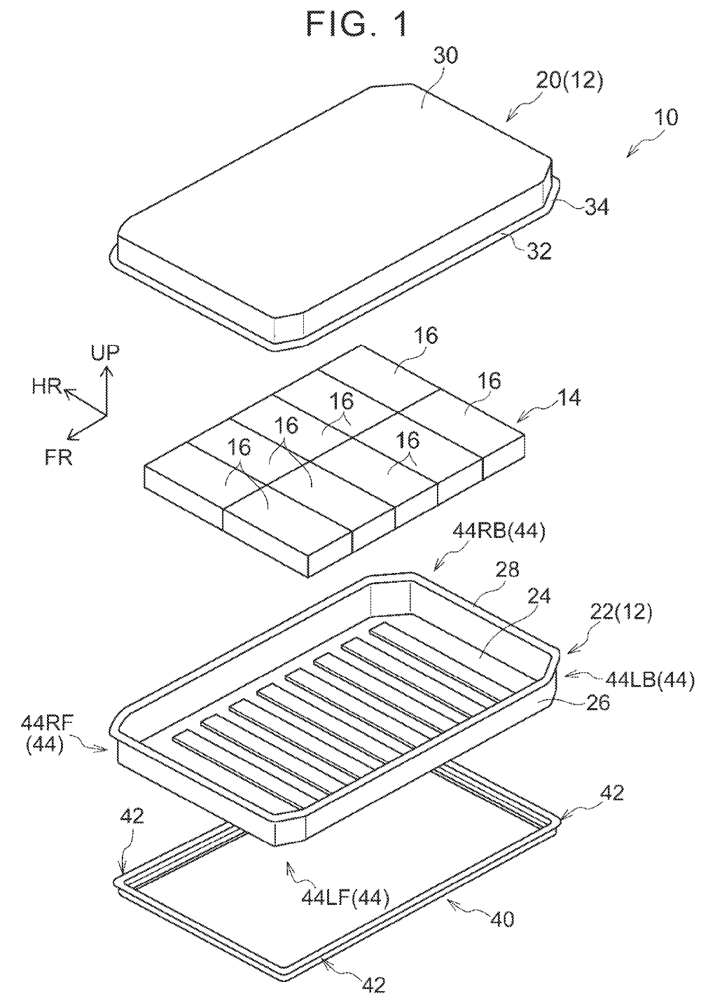

FIG. 1 is a perspective view illustrating a schematic configuration of a battery 10 according to the embodiment. In the drawings, a forward direction in a front-rear direction of the vehicle is indicated by an arrow FR, a rightward direction in a width direction of the vehicle is indicated by an arrow HR, and an upward direction is indicated by an arrow UP.

The battery 10 is mounted, for example, in a vehicle (not shown) that includes an electric motor serving as a drive source for traveling, and outputs direct current (DC) power that can be used to drive the electric motor. The vehicle in which the battery 10 is mounted includes a hybrid electric vehicle (HEV), a plug-in hybrid electric vehicle (PHEV), a battery electric vehicle (BEV), and the like.

As illustrated in FIG. 1, the battery 10 includes a battery case 12 serving as the vehicle battery case and a case body according to the embodiment, and a battery pack 14 housed in the battery case 12. The battery case 12 is disposed below a floor panel serving as a floor of the vehicle and above an undercover, and is attached to a vehicle body (they are not shown).

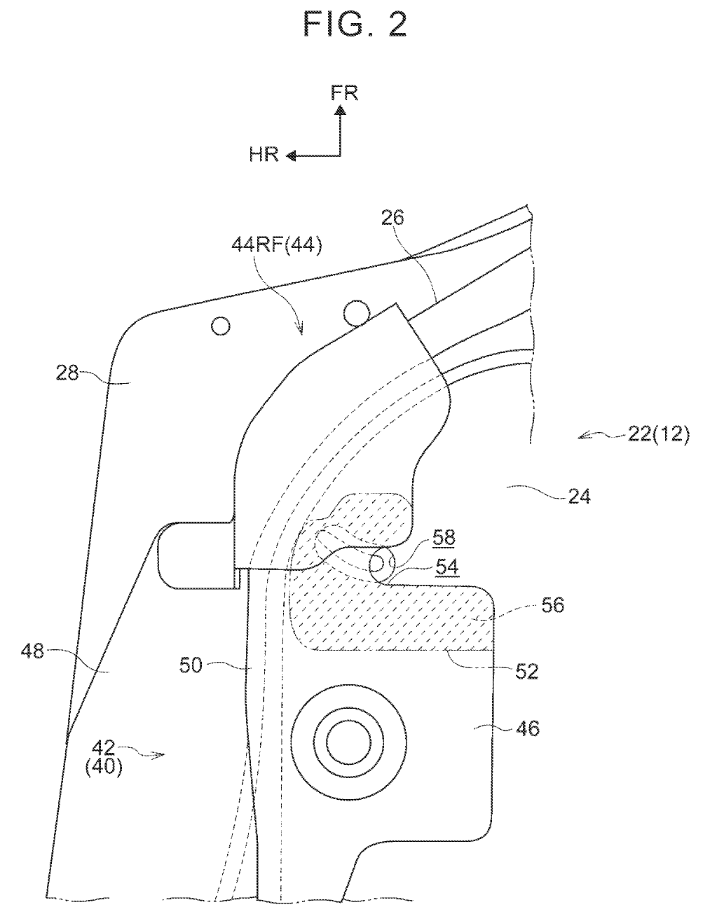

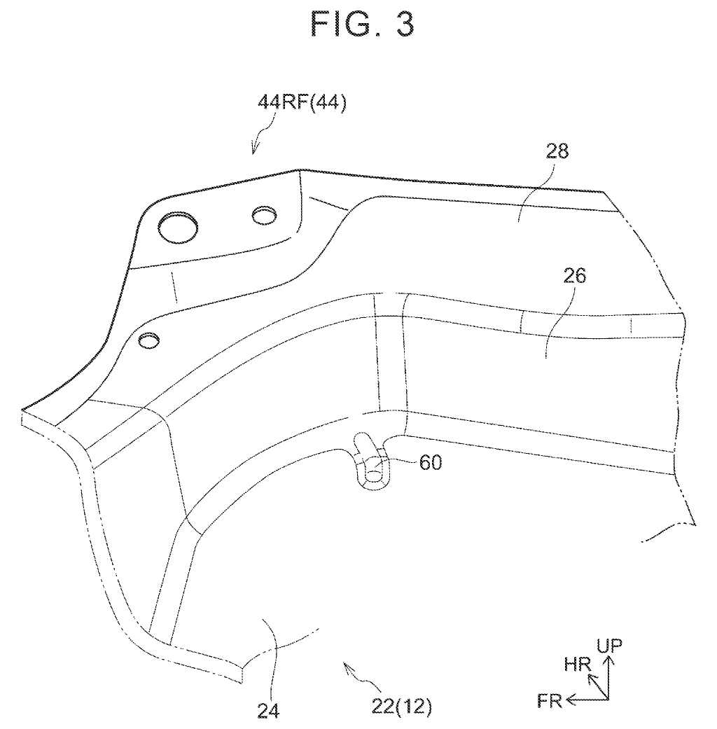

The battery case 12 includes an upper case 20 and a lower case 22. The upper case 20 and the lower case 22 are opposed to each other with the upper case 20 positioned on the upper side and the lower case 22 positioned on the lower side. FIG. 2 is a plan view illustrating a main portion of the lower case 22 as viewed from below (backside view), and FIG. 3 is a perspective view illustrating an outline of the main portion of the lower case 22 as viewed from above on a rear left side.

As shown in FIGS. 1 to 3, the lower case 22 is made of a steel plate or the like, and includes a bottom plate 24 that is generally rectangular in plan view and has a flat backside. The lower case 22 includes a peripheral wall 26 erected around the bottom plate 24. A flange portion 28 is provided around substantially the entire circumference of the peripheral wall 26 such that the upper portion of the lower case 22 is bent outward of the lower case 22. The lower case 22 includes the bottom plate 24, the peripheral wall 26, and the flange portion 28 that are integrally provided, and the lower case 22 has a generally rectangular tray shape (or a basin shape).

The upper case 20 is made of a steel plate or the like, and includes a top plate 30 that is generally rectangular in plan view. In addition, the upper case 20 includes a peripheral wall 32 that projects downward around the top plate 30. In the upper case 20, a flange portion 34 is provided around substantially the entire circumference of the peripheral wall 32 such that an end portion (lower end portion) of the upper case 20 is bent outward of the upper case 20. The upper case 20 includes the top plate 30, the peripheral wall 32, and the flange portion 34 that are integrally provided.

In the battery case 12, the upper case 20 and the lower case 22 are assembled after having been coated and treated for rust resistance in advance. At this time, in the battery case 12, the flange portion 34 of the upper case 20 and the flange portion 28 of the lower case 22 are stacked to face each other. In addition, in the battery case 12, the flange portion 34 of the upper case 20 and the flange portion 28 of the lower case 22 are assembled by fastening them together using fastening means such as bolts and nuts, and an internal space is sealed from the surroundings (not shown).

In the battery case 12, the boundary between the top plate 30 and the peripheral wall 32 of the upper case 20 and the boundary between the bottom plate 24 and the peripheral wall 26 of the lower case 22, etc. are chamfered.

In the battery 10, a battery pack 14 made up of one or more battery modules 16 is housed in the internal space of the battery case 12. The battery modules 16 are disposed in arrays within the battery case 12 and are covered from the top and bottom by the top plate 30 and the bottom plate 24, and are surrounded by the peripheral wall 26 and the peripheral wall 32. Thus, the battery case 12 functions as a battery pack case in which the battery pack 14 is housed.

The battery modules 16 each include a plurality of stacked battery cells (not shown). In the battery 10, for example, the battery modules 16 are connected in parallel or in series, and the battery 10 outputs DC power of a required voltage during discharging. In addition, in the battery 10, DC power of a required voltage is received, so that each of the battery cells of the battery modules 16 is charged. The battery case 12 may be in a form in which the battery case 12 houses only one battery module 16, rather than multiple battery modules 16. The battery case 12 may be in a form in which the battery case 12 houses one or more hydrogen tanks used for fuel cells in addition to the battery modules 16.

Meanwhile, a support frame 40 including other parts (members) is attached to the battery case 12, and the battery case 12 is attached to the vehicle body via the support frame 40. In the embodiment, the support frame 40 is attached to the lower case 22, and the lower case 22 is attached to the vehicle body via the support frame 40. The support frame 40 also includes mounting parts made of a steel plate, and the support frame 40 can be subjected to coating together with the lower case 22 with the mounting parts made of the steel plate attached to the lower case 22.

For example, the support frame 40 has a rectangular frame shape in plan view by connecting a plurality of parts, and the support frame 40 faces a peripheral edge portion of the bottom plate 24 below the lower case 22. The support frame 40 is attached, for example, straddling the bottom plate 24 and the peripheral wall 26.

The support frame 40 includes a framework part 42 serving as an mounting part that is a separate part from the parts that make up the battery case 12 and is attached to the outer surface of the battery case 12 such that the mounting part is in surface contact with the outer surface. The framework part 42 is in surface contact with an undersurface of the bottom plate 24 of the lower case 22.

The lower case 22 (battery case 12) has corners 44 at its four corners. In the embodiment, as an example, the framework part 42 is described as being attached to one of the four corners 44, a corner 44RF on the front side of the lower case 22 in the front-rear direction of the vehicle and on the right side of the lower case 22 in the width direction of the vehicle, and a corner 44LF on the front side of the lower case 22 in the front-rear direction of the vehicle and on the left side of the lower case 22 in the width direction of the vehicle. In addition, in the embodiment, the corner 44RF will be mainly described, and the description of the corner 44LF will be omitted. Note that the framework part 42 may be attached to a corner 44RB on the rear side of the lower case 22 in the front-rear direction of the vehicle and on the right side of the lower case 22 in the width direction of the vehicle, and a corner 44LB on the rear side of the lower case 22 in the front-rear direction of the vehicle and on the left side of the lower case 22 in the width direction of the vehicle.

As shown in FIG. 2, the framework part 42 includes a support portion 46 that faces the undersurface of the bottom plate 24 of the lower case 22, and an overhanging portion 48 that is located outside the bottom plate 24 (outside the lower case 22 relative to the bottom plate 24). The framework part 42 also includes a connecting portion 50 that faces the outer surface of the peripheral wall 26 of the lower case 22. The connecting portion 50 of the framework part 42 connects the support portion 46 and the overhanging portion 48 together to provide a single unit.

The support portion 46 of the framework part 42 is provided with a flat portion 52 that is in surface contact with the undersurface of the bottom plate 24. Furthermore, the flat portion 52 has a notch 54 at a central portion in the front-rear direction of the vehicle. The notch 54 extends from the left side toward the right side in the width direction of the vehicle. In FIG. 2, the outline (outer shape) of the flat portion 52 is indicated by a two-dot chain line.

On the other hand, an area of the bottom plate 24 of the lower case 22 that is in surface contact with the flat portion 52 of the framework part 42 is a contact area 56 (an area hatched by dashed lines in FIG. 2). The bottom plate 24 is provided with a recess 58 in the contact area 56. The recess 58 is groove-shaped and opens to the backside of the bottom plate 24. One end side is located on the corner 44RF side in the contact area 56 and the other end side extends outward of the contact area 56. The end of the recess 58 opposite from the corner 44RF reaches into the notch 54 of the framework part 42. Accordingly, the recess 58 provided in the bottom plate 24 so as to extend from a position corresponding to the notch 54 of the support portion 46 toward the corner 44RF. The recess 58 is inclined with respect to both the front-rear direction and the width direction of the vehicle so as to extend toward the right side in the width direction of the vehicle toward the front of the vehicle.

As shown in FIG. 3, the recess 58 is provided in the lower case 22, so that a bead portion 60 is provided so as to project from the upper surface of the bottom plate 24 (the surface opposite to the undersurface, the surface facing the internal space). The bead portion 60 projects from the upper surface of the bottom plate 24 and extends along the recess 58. That is, the bead portion 60 is provided on the upper surface of the bottom plate 24 so as to extend from the corner 44RF side toward the left side in the width direction of the vehicle (the inner side in the width direction of the vehicle) toward the rear side in the front-rear direction of the vehicle in the same manner as the recess 58.

Due to the recess 58 provided on one surface side (undersurface side) in a thickness direction of the bottom plate 24, the thickness of the bottom plate 24 is thin, resulting in decrease in strength. Here, in the bottom plate 24, the bead portion 60 is provided to project from the other surface side (upper surface side) in the thickness direction so as to compensate for the change in thickness caused by providing the recess 58. Accordingly, providing the bead portion 60 in the lower case 22 restrains a decrease in strength in the thickness direction of the bottom plate 24 caused by a reduction in the thickness of the bottom plate 24 due to the recess 58.

Note that a recess 58 and a bead portion 60 are associated with the framework part 42 attached to the corner 44LF, and are provided near the corner 44LF of the bottom plate 24 (not shown). In this case, the recess 58 and the bead portion 60 are provided so as to extend inward in the width direction of the vehicle (to the right side in the width direction of the vehicle) from the corner 44LF side toward the rear side in the front-rear direction of the vehicle.

Next, an operation of the embodiment will be described.

The battery 10 includes the battery case 12. In the battery case 12, the battery modules 16 in which the battery cells are stacked are disposed (fixed) on the lower case 22 and are covered by the upper case 20. Accordingly, the battery 10 includes the battery modules 16 (battery pack 14) housed in the battery case 12.

In the battery 10, the support frame 40 is attached to the lower case 22 of the battery case 12, and the lower case 22 is attached to the vehicle body via the support frame 40, so that the battery case 12 is supported on the vehicle body. As a result, the battery 10 is mounted in the vehicle.

On the other hand, for vehicles, electrodeposition coating is often used in the formation of coating films on various parts. In the electrodeposition coating, for example, an epoxy resin or the like is used as a base substance, and a cationic electrodeposition coating liquid containing a cationic resin is applied as a coating. In the cationic electrodeposition coating, the upper case 20 or the lower case 22 to be coated is immersed in a cationic coating liquid in which the cationic resin is positively (+) charged. In addition, in the electrodeposition coating, the upper case 20 or the lower case 22 is used as one electrode (cathode) of a pair of electrodes (anode and cathode), and an electrodeposition voltage according to preset electrodeposition conditions is applied across the one electrode and the other electrode (anode) placed in the coating liquid. A coating (coating components) in the coating liquid is deposited on the surface of the upper case 20 or the lower case 22, and the objects to be coated are covered with a coating film (resin coating film) (a coating film is formed).

In such electrodeposition coating, by subjecting the lower case 22 to which the mounting part 42 is attached to coating, it is possible to coat the mounting part 42 together with the lower case 22. At this time, since the flat portion 52 of the mounting part 42 is in surface contact with the lower case 22, uneven coating is likely to occur, such as a thin coating film in the contact area 56 or an exposed base material.

Here, the recess 58 is provided in the contact area 56 in the bottom plate 24 of the lower case 22 where the flat portion 52 of the mounting part 42 is in surface contact with the bottom plate 24. The recess 58 extends from the contact area 56 to a position corresponding to the notch 54 of the framework part 42, namely a position that is a non-contact area. The non-contact area of the lower case 22 is open and serves as an area to which the coating liquid adheres.

Therefore, in the bottom plate 24 of the lower case 22, the coating liquid can enter the recess 58 that is opened due to the notch 54, and the coating liquid is supplied to the contact area 56. That is, the recess 58 extending from the non-contact area into the contact area 56 provides a non-contact area within the contact area 56. Therefore, in the bottom plate 24 to which the framework part 42 is attached, the recess 58 restrains producing an area separated from the non-contact area within the contact area 56.

Therefore, the coating liquid can be supplied to the contact area 56 where the framework part 42 is in surface contact with the bottom plate 24 of the lower case 22, and the coating film is formed within the contact area 56 by the coating liquid. Similarly, a coating film is also formed on the surface of the flat portion 52 of the framework part 42 that is in contact with the bottom plate 24 and faces the bottom plate 24.

In this way, even when the framework part 42 is attached to the lower case 22 such that the framework part 42 is in surface contact with the lower case 22, an appropriate coating film is formed, which restrains the base material from being exposed. This reliably restrains rust from being formed or the formed rust progressing in the lower case 22 and the battery case 12 provided in the lower case 22.

On the other hand, when the vehicle body receives an impact in the event of an emergency of the vehicle, the battery case 12 receives a load corresponding to the impact. At this time, in the battery case 12, the recess 58 that opens downward is provided on the undersurface side of the bottom plate 24 of the lower case 22, so that the bead portion 60 is provided on the internal space side. Therefore, in the battery case 12, the rigidity of the bottom plate 24 of the lower case 22 is improved, and deformation or the like caused when the battery case 12 is subjected to an external force is restrained.

The bead portions 60 near the respective corners 44RF, 44LF of the lower case 22 are inclined with respect to both the front-rear direction and the width direction of the vehicle. Therefore, with the lower case 22 used in the battery case 12, rigidity against loads in the front-rear direction and the width direction of the vehicle is improved. This restrains deformation of the battery case 12 even when the battery case 12 receives loads on the front side in the front-rear direction of the vehicle or both sides in the width direction of the vehicle in the event of an emergency of the vehicle, so that the battery pack 14 housed in the battery case 12 can be protected.

In the battery case 12, the recesses 58 are provided in the respective corners 44RF, 44LF of the lower case 22, and the bead portions 60 are provided. However, the recesses 58 and the bead portions 60 may be provided in the respective corners 44RB, 44LB on the rear side of the lower case 22 in the front-rear direction of the vehicle. This allows the battery case 12 to improve its rigidity against loads received on the rear side in the front-rear direction of the vehicle and both sides in the width direction of the vehicle in the rear portion. Accordingly, the battery pack 14 can be protected against the loads received on the rear side in the front-rear direction of the vehicle and both sides in the width direction of the vehicle in the rear portion.

In the embodiment, the recess 58 is provided in the contact area 56 between the lower case 22 and the framework part 42 such that the recess 58 reaches the notch 54 in the framework part 42. However, the recess 58 simply has to be provided such that it extends from the contact area 56 with the framework part 42 to the non-contact area that is not in contact with the framework part 42.

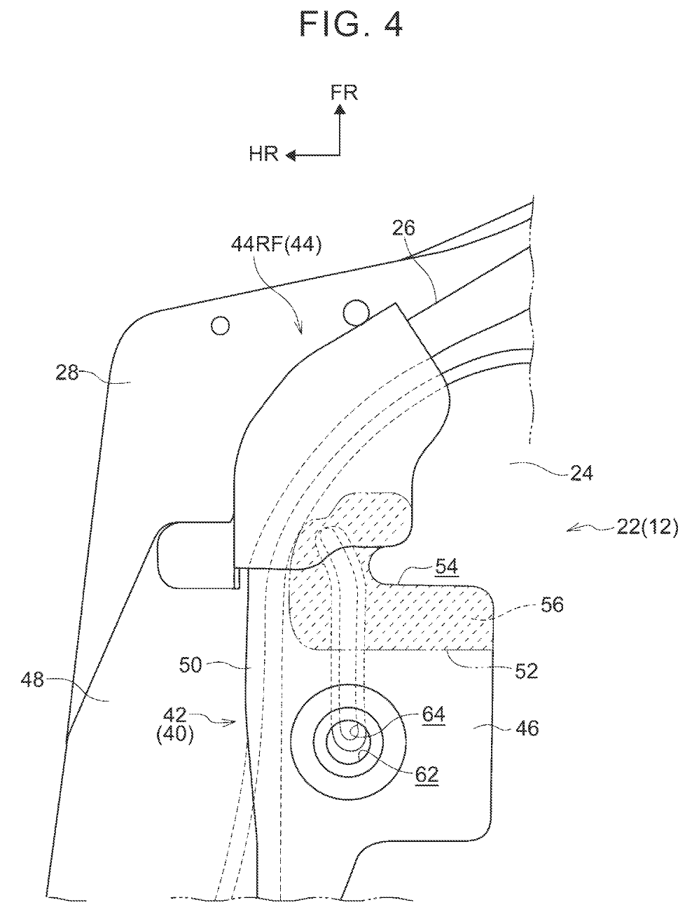

FIG. 4 is a plan view (backside view) of the main part of the lower case 22 according to a modification as viewed from below. In the modification, a circular hole 62 is provided in the support portion 46 of the framework part 42 so as to be located behind the flat portion 52 in the front-rear direction of the vehicle, and the circular hole 62 penetrates the support portion 46 in an up-down direction. Thus, the undersurface of the lower case 22 opens downward due to the circular hole 62.

For the such framework part 42, the bottom plate 24 of the lower case 22 may be provided with a recess 64 extending from within the contact area 56 to a position facing the circular hole 62 of the support portion 46. This allows the coating liquid that has entered the circular hole 62 of the support portion 46 to enter the recess 64. Therefore, the coating liquid can enter a portion between the bottom plate 24 and the flat portion 52 from the recess 64 in the contact area 56 of the bottom plate 24 of the lower case 22, and can adhere to the portion.

Therefore, even when the recess 64 is provided in the bottom plate 24 instead of the recess 58, it is possible to restrain uneven coating, such as a thin coating film and an exposed base material of the bottom plate 24, as in the case where the recess 58 is provided. Thus it is possible to restrain the formation of rust and the progression of rust in the lower case 22.

In the embodiment and the modification, the recesses 58, 64 are provided in the bottom plate 24 of the lower case 22. However, recesses may be provided for a mounting part that is attached to the top plate 30 of the upper case 20 so as to be near the corners 44. At this time, bead portions are preferably provided in correspondence with the recesses. This makes it possible to restrain uneven coating or the like on the top plate 30 of the upper case 20, and restrain the formation and progression of rust. Furthermore, the bead portions provided together with the recesses improve the rigidity of the upper case 20, thereby improving the rigidity of the battery case 12.

The recesses are not limited to being provided at the corners, but may be provided near straight portions between the corners. That is, the recesses may be provided in mounting parts that are attached to the outer surface of the peripheral wall 32 of the upper case 20 and the outer surface of the peripheral wall 26 of the lower case 22. This makes it possible to restrain uneven coating on the peripheral wall 32 of the upper case 20 and the peripheral wall 26 of the lower case 22, and also makes it possible to improve the rigidity of each of the peripheral walls 26, 32 by the bead portions provided in correspondence with the recesses.

What is claimed is:

1. A vehicle battery case comprising:
a case body that houses a battery module including a plurality of stacked battery cells in an internal space; and
a mounting part that is subjected to coating together with the case body, the mounting part being attached to an outer surface of the case body such that the mounting part is in surface contact with the outer surface, wherein the outer surface of the case body is provided with a groove-shaped recess that extends from a contact area to a non-contact area that does not contact with the mounting part, the contact area being in surface contact with the mounting part with the mounting part attached.

2. The vehicle battery case according to claim 1, wherein:
the case body includes a lower case on which the battery module is mounted; and
an upper case covering the lower case and defining an internal space that is between the upper case and the lower case and in which the battery module is housed; and
the recess is provided in the lower case.

3. The vehicle battery case according to claim 2, wherein the recess is provided in a front end of the lower case in a front-rear direction of a vehicle.
